(19) United States
(12) Patent Application Publication
(10) Pub. No.: US 2010/0034328 A1
(43) Pub. Date: Feb. 11, 2010

(54) SIGNAL RECEIVING APPARATUS, BROADCAST RECEIVING APPARATUS AND SIGNAL PROCESSING METHOD USING THE SAME

(75) Inventor: Kyoung-shin Jin, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/468,085

(22) Filed: May 19, 2009

(30) Foreign Application Priority Data
Aug. 8, 2008 (KR) 10-2008-0077813

(51) Int. Cl. H04B 1/10

(52) U.S. Cl. 375/346

(57) ABSTRACT

A signal receiving apparatus, a broadcast receiving apparatus and a signal processing method using the same are provided. An amplifying unit amplifies a received signal. A digital demodulating unit demodulates a signal amplified and output from the amplifying unit and extracts a transfer stream of the demodulated signal. A control unit controls on and off states of the amplifying unit. Accordingly, even a signal of high level of magnitude can be amplified if the signal has degrading quality.

### CROSS-REFERENCE TO RELATED APPLICATIONS

This application claims priority from Korean Patent Application No. 10-2008-0077813 filed Aug. 8, 2008, in the Korean Intellectual Property Office, the disclosure of which is incorporated herein by reference in its entirety.

### BACKGROUND OF THE INVENTION

1. Field of the Invention

Apparatuses and methods consistent with the present invention relate to a signal processing, and more particularly, to amplifying a degraded signal.

2. Description of the Related Art

Generally, a tuner is the device operating to select one of broadcast signals received by wires or wirelessly, and amplify and demodulate the selected signal into a form suitable for viewing by the viewers.

A tuner includes a low noise amplifier (LNA) which generally has a fixed signal amplification mode until the power is turned on/off or channel is changed. This means that if high quality signal is input immediately after the power is turned on or channel is changed, the LNA keeps off state unless a specific event, such as a channel change, happens.

Therefore, the tuner continuously receives a degraded signal without amplification until the specific event happens.

In other approaches, the LNAs decide whether to be in amplification on or off mode according to the magnitude of the received signal. This can be problematic, since a degraded signal can be continuously received without an amplification as long as the signal has high level of magnitude.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a signal receiving apparatus, a broadcast receiving apparatus, and a signal processing method using the same, which amplify a degraded signal, regardless of whether the signal has a high level of magnitude.

According to an exemplary aspect of the present invention, there is provided a signal receiving apparatus, which includes an amplifying unit which amplifies a received radio frequency (RF) signal, a digital demodulating unit which demodulates a signal amplified and output from the amplifying unit and extracts a transfer stream of the demodulated signal, and a control unit which measures a signal to noise ratio (SNR) of the transfer stream and controls an operational status of the amplifying unit according to the measured SNR.

The control unit may measure the SNR at predetermined time intervals to control on and off states of the amplifying unit.

The control unit may compare the SNR with a first threshold and a second threshold which is smaller than the first threshold. If the SNR is larger than the first threshold, the control unit may turn the amplifying unit into an off state, or if the SNR is smaller than the second threshold, the control unit may turn the amplifying unit into an on state.

The amplifying unit may include a low noise amplifier (LNA).

According to an exemplary aspect of the present invention, there is provided a broadcast receiving apparatus, which includes a tuner unit to amplify a broadcast signal, and demodulate the amplified broadcast signal to extract a transfer stream, and a control unit to measure a signal to noise ratio (SNR) using the transfer stream, and control whether the tuner unit performs amplification or not based on the measured SNR.

The broadcast receiving apparatus may further include a storage unit which stores therein a first and second thresholds, so that if the SNR is larger than the first threshold, the control unit generates a control signal to cause the broadcast signal not to be amplified, or if the SNR is smaller than the second threshold, the control unit generates a control signal to cause the broadcast signal to be amplified.

According to an exemplary aspect of the present invention, there is provided a signal processing method, which includes extracting a transfer stream of a received radio frequency (RF) signal, measuring a signal to noise ratio (SNR) of the transfer stream, comparing the SNR of the transfer stream with at least one threshold, and operating an amplifier, which is provided to amplify the RF signal, based on the result of the comparing.

The extracting, the measuring, the comparing and the operating may be performed repeatedly at predetermined time intervals.

The measuring may include measuring the SNR of the transfer stream at predetermined time intervals.

The operating may include turning the amplifying unit into on state or off state.

The comparing may include comparing the SNR with a first threshold and a second threshold which is smaller than the first threshold, so that if the SNR is larger than the first threshold, turning the amplifying unit into off state, or if the SNR is smaller than the second threshold, turning the amplifying unit into on state.

The amplifying unit may include a low noise amplifier (LNA).

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a view illustrating a tuner according to an exemplary embodiment of the present invention;

FIG. 2 is a view provided to explain a signal processing method according to an exemplary embodiment of the present invention; and

FIG. 3 is a block diagram of a digital television (DTV) according to an exemplary embodiment of the present invention.

### DETAILED DESCRIPTION OF EXEMPLARY EMBODIMENTS

Exemplary embodiments of the present invention will now be described in greater detail with reference to the accompanying drawings.

In the following description, same drawing reference numerals are used for the same elements even in different drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

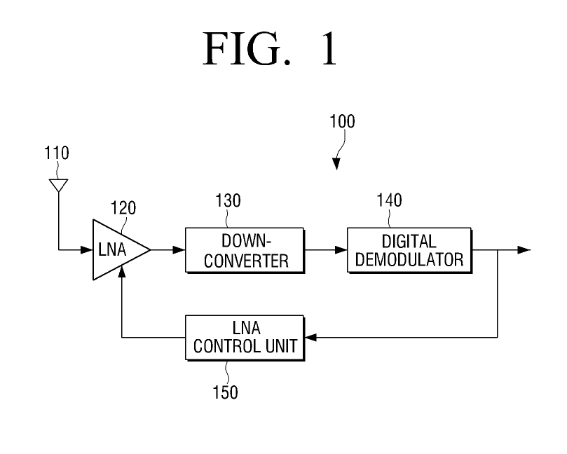

FIG. 1 illustrates a tuner according to an exemplary embodiment of the present invention. According to an aspect of the present invention, a tuner 100 selects one of the broadcast signals received by wires or wirelessly, and demodulates the selected signal into a form viewable by the viewer. The tuner 100 may include an antenna 110, a low noise amplifier (LNA) 120, a down-converter 130, a digital demodulator 140, and an LNA control unit 150.

The antenna 110 detects a radio frequency (RF) signal of high frequency band in the air. Specifically, the antenna 110 receives an RF signal in the form of an electromagnetic wave from the air, and converts the received electromagnetic wave into an electronic form of RF signal along a conductive line. The antenna 110 transfers the RF signal to the LNA 120.

The LNA 120 amplifies the RF signal entailed with a noise signal from the air. A signal received via the antenna 110 needs amplification, since this signal has a very low electronic level due to the influence of attenuation and noise. Furthermore, since the signal already includes noise from outside, the amplification is required, which keeps the noise as low as possible. The LNA 120 is the amplifier designed to keep a low noise factor (NF), and thus is capable of amplifying a received RF signal while minimizing the noise signal.

The LNA 120 performs amplification only when the RF signal includes an excessive noise. That is, the LNA 120 turns to amplification on or off mode according to the control signal of the LNA control unit 150 which is explained in detail below. Therefore, according to the control of the LNA control unit 150, the LNA 120 transfers amplified or non-amplified RF signal to the down-converter 130.

The down-converter 130 converts an RF signal output from the LNA 120 into a signal in the IF frequency band and converts the signal in the IF frequency band into a digital IF signal.

The digital demodulator 140 is connected to an output terminal of the down-converter 130, to demodulate a digital IF signal into a baseband transfer stream by removing the frequency and phase errors existent in the digital IF signal. The transfer stream output from the digital demodulator 140 is transmitted to an external device and the LNA control unit 150.

The LNA control unit 150 measures a signal to noise ratio (SNR), using the transfer stream output from the digital demodulator 140. The SNR is the reference to measure quality of a digital signal which is susceptible to noise characteristic. Specifically, the SNR is distinguished from the carrier to noise ratio (CNR) in that the SNR is the final resultant signal quality value obtained after the processing the influence related with strong or weak signal, or signal fading.

Therefore, by determining whether to start amplification based on the SNR, the signal degrading due to problems such as fading can be resolved even when the signal has a good CNR or high level of magnitude.

The LNA control unit 150 compares the SNR with a predetermined threshold to determine whether to have the LNA 120 in an on or an off state. Specifically, the LNA control unit 150 compares the SNR to a first threshold. The LNA 120 is turned to the off state if the SNR is greater than the first threshold. The LNA control unit 150 compares the SNR with a second threshold if the SNR is smaller than or equal to the first threshold. The LNA control unit 150 turns the LNA 120 to the on state if the SNR is smaller than the second threshold.

The first threshold corresponds to the SNR at which the LNA 120 does not need amplification. The second threshold corresponds to the SNR at which the LAN 120 needs amplification. The first and second thresholds may be predetermined and provided to the user, or adjusted by the user.

The LNA control unit 150 keeps the LNA 120 in the current state if the SNR is smaller than or equal to the first threshold and greater than or equal to the second threshold. Accordingly, the LNA control unit 150 keeps the LNA 120 in on state if the LNA 120 has been in on state, or keeps the LNA 120 in off state if the LNA 120 has been in off state.

The LNA control unit 150 may be designed to control the on and off states of the LNA 120 at predetermined time intervals. Therefore, in addition to controlling the on and off states of the LNA 120 as a specific event such as channel change happens, the LNA control unit 150 also periodically measures the SNR and controls the on and off states of the LNA 120 accordingly. As a result, the LNA 120 may be controlled to properly deal with a situation where the signal currently having a good quality degrades during the reception.

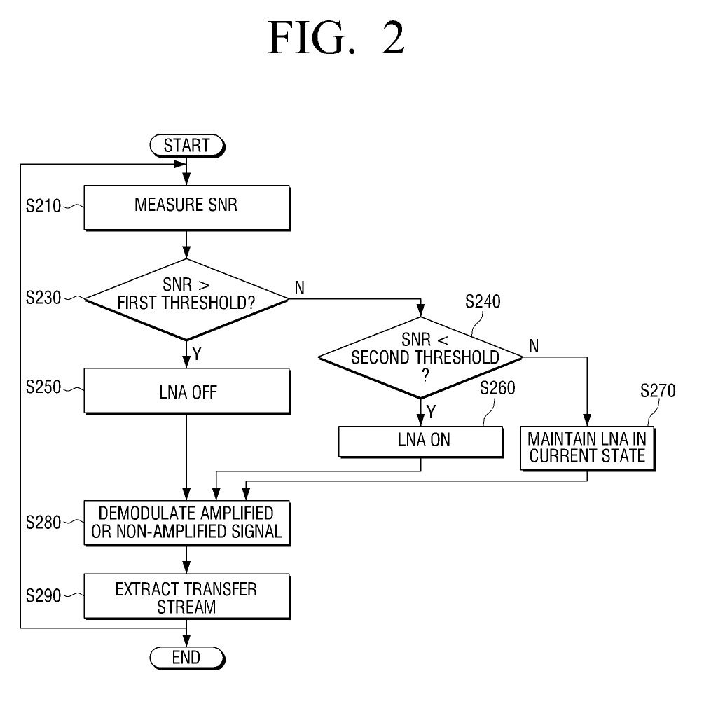

FIG. 2 is a view provided to explain a signal processing method according to an exemplary embodiment of the present invention.

The LNA control unit 150 measures the SNR of a transfer stream output from the digital demodulator 140 at S210, and determines if the measured SNR is greater than the first threshold at S230.

The LNA control unit 150 turns the LNA 120 into off state if the measured SNR is greater than the first threshold at S250, or determines if the measured SNR is smaller than the second threshold if the measured SNR is equal to or smaller than the first threshold at S240.

If the measured SNR is smaller than the second threshold, the LNA control unit 150 turns the LNA 120 into on state at S260, and if the measured SNR is equal to or greater than the second threshold, keeps the LNA 120 in the current state at S270. That is, if the SNR is equal to or smaller than the first threshold and equal to or greater than the second threshold, the LNA control unit 150 keeps the LNA 120 in the current state, regardless of whether the LNA 120 is currently in the on or off state.

An RF signal, whether amplified or non-amplified, according to the on or off state of the LNA 120, is sent to the down-converter 130 to be converted into an IF signal. The IF signal is sent to the digital demodulator 140 to be demodulated at S280.

The LNA control unit 150 extracts a transfer stream of the IF signal demodulated at the digital demodulator 140 at S290, and re-measures SNR based on the extracted transfer stream at S210.

Accordingly, even a signal having high CNR or high level of magnitude, may be amplified if the signal has a degrading quality due to noise or the like.

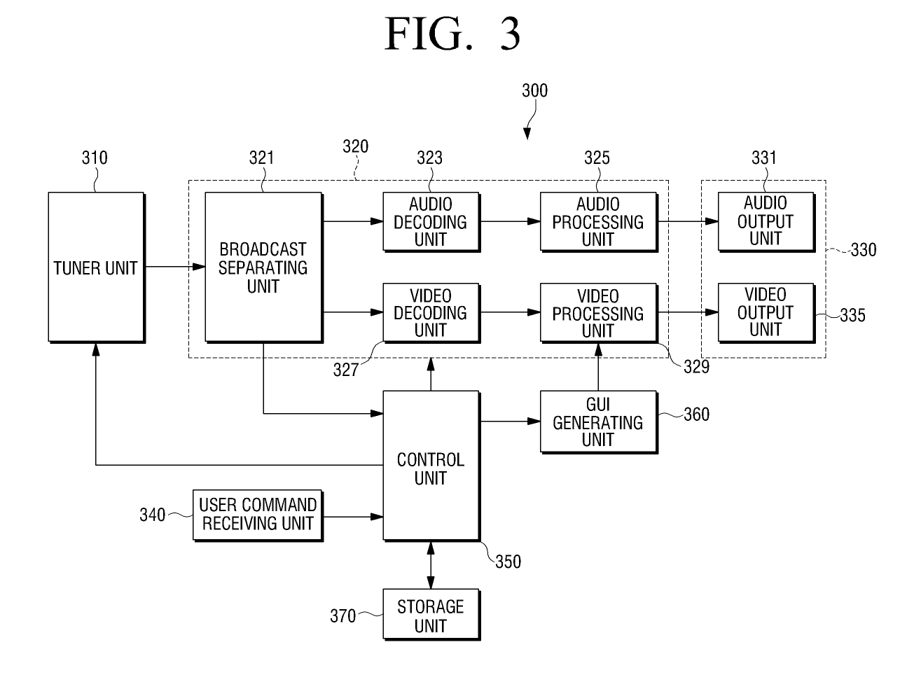

FIG. 3 is a block diagram of a digital television 300 according to an exemplary embodiment of the present invention. According to an exemplary aspect of the present invention, the DTV 300 provides a digital broadcast program in a form viewable by the viewer.

The DTV 300 according to an exemplary embodiment of the present invention may include a tuner unit 310, a broadcast processing unit 320, a broadcast output unit 330, a user command receiving unit 340, a control unit 350, a graphical user interface (GUI) generating unit 360, and a storage unit 370.

The tuner unit 310 selects one of the broadcast signals received by wires or wirelessly, amplifies the selected broadcast signal, demodulates the amplified broadcast signal, and extracts a transfer stream. The tuner unit 310 includes an amplifier to amplify the selected broadcast signal.

Specifically, the tuner unit 310 receives an RF signal of high frequency band from the air and determines whether to amplify the received RF signal according to the control of the control unit 350 which is explained in detail below.

Additionally, the tuner unit 310 converts the RF signal into a signal in the IF frequency band, converts the signal in the IF frequency band into a digital IF signal, and demodulates the digital IF signal into a transfer stream in the baseband by removing frequency and phase errors existent in the digital IF signal. After demodulation, the transfer stream is transmitted to the control unit 350.

The broadcast processing unit 320 processes a broadcast signal output from the tuner unit 310. The broadcast processing unit 320 may include a broadcast separating unit 321, an audio decoding unit 323, an audio processing unit 325, a video decoding unit 327, and a video processing unit 329.

The broadcast separating unit 321 separates a broadcast signal output from the tuner unit 310 into video signal, audio signal and additional information, and outputs the result.

The video and audio signals separated from the broadcast signal are sent to the video processing unit 329 and the audio processing unit 325 respectively, to be used to provide a digital broadcast program.

The additional information signal separated from the broadcast signal is sent to the control unit 350, to be used to provide an additional information service.

The audio decoding unit 323 decodes an audio signal output from the broadcast separating unit 321. Accordingly, the audio decoding unit 323 outputs a decompressed audio signal.

The audio processing unit 325 converts the decoded audio signal output from the audio decoding unit 323 into an audio signal in a format suitable for output through a speaker.

The video decoding unit 327 decodes the video signal output from the broadcast separating unit 321. Accordingly, the video decoding unit 327 outputs a decompressed video signal.

The video processing unit 329 converts the decoded video signal output from the video decoding unit 327 into a video signal in a format suitable for output through a display. To do this, the video processing unit 329 performs color signal processing, scaling, or the like, with respect to the decoded video signal.

The GUI generating unit 360 generates a GUI to be output through a display, using the additional information signal output from the control unit 350. The GUI, which is generated at the GUI generating unit 360, is sent to the video processing unit 329 and added to a video to be output through the display, in a processing which is generally referred to as an on-screen display (OSD).

The output unit 330 outputs a video and an audio corresponding to the video and audio signals output from the broadcast processing unit 320 to provide them to the user. To do this, the output unit 330 may include an audio output unit 331 and a video output unit 335.

The audio output unit 331 outputs the audio signal received from the audio processing unit 325 through a speaker or through an external display such as an external TV, which is connected to an external output terminal.

The video output unit 335 outputs the video signal received from the video processing unit 329 through a display or through an external display such as an external TV, which is connected to an external output terminal.

The storage unit 370 is a storage medium which records therein programs to drive the DTV 300, and may be embodied as a memory, or hard disk drive (HDD). The storage unit 370 additionally stores therein the first and second thresholds for comparison to the SNR.

The user command receiving unit 340 transfers a user command received through a remote controller to the control unit 350, so that the control unit 350 controls the overall operation of the DTV 300 according to the user command received via the user command receiving unit 340.

Specifically, the control unit 350 measures the SNR of the transfer stream received from the tuner unit 310, compares the SNR with the thresholds stored in the storage unit 370, and controls the tuner unit 310 accordingly.

Specifically, the control unit 350 measures the SNR of the transfer stream received from the tuner unit 310, and compares the measured SNR with the first threshold. If the SNR is greater than the first threshold, the tuner unit 310 does not perform the amplification through an amplifier, such as a low noise amplifier. If the SNR is smaller than the second threshold, the tuner unit 310 starts the amplification through the amplifier.

As a result, even a signal with a high CNR or high level of magnitude may be properly amplified by the amplifier based on the SNR, so that a high quality output may be obtained.

Although the LNA or amplifier is controlled with reference to the first and second thresholds in the exemplary embodiments explained above, this is only for the purpose of convenience of the explanation. Therefore, the concept of the present invention is not limited, and applicable to the cases of controlling the LNA or amplifier based on one threshold value, or more than two threshold values.

For example, the degree of amplitude may be determined, depending on which of a plurality of reference levels the SNR falls to.

Furthermore, although the amplification at the tuner unit has been explained with respect to the DTV in the exemplary embodiments explained above, this should not be construed limiting, and the technical concept of the present invention is applicable to any type of devices which is capable of signal tuning.

The foregoing exemplary embodiments and advantages are merely exemplary and are not to be construed as limiting the present invention. The present exemplary teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A signal receiving apparatus, comprising:
an amplifying unit which selectively amplifies and outputs a received radio frequency (RF) signal;
a digital demodulating unit which demodulates the RF signal output from the amplifying unit and extracts a transfer stream from the demodulated RF signal; and
a control unit which measures a signal to noise ratio (SNR) of the transfer stream and controls an operational status of the amplifying unit based on the measured SNR.

2. The signal receiving apparatus of claim 1, wherein the control unit measures the SNR at predetermined time intervals to control an amplification on state and an amplification off state of the amplifying unit.

3. The signal receiving apparatus of claim 1, wherein the control unit compares the measured SNR with a first threshold and a second threshold, which is smaller than the first threshold, and wherein, if the SNR is greater than the first threshold, the control unit turns the amplifying unit to an amplification off state, or, if the measured SNR is smaller than the second threshold, the control unit turns the amplifying unit to an amplification on state.

4. The signal receiving apparatus of claim 1, wherein the amplifying unit comprises a low noise amplifier (LNA).

5. A broadcast receiving apparatus, comprising:
a tuner unit which selectively amplifies a broadcast signal, demodulates the broadcast signal, and extracts a transfer stream from the demodulated broadcast signal; and
a control unit which measures a signal to noise ratio (SNR) of the transfer stream and controls the tuner unit to perform amplification of the broadcast signal based on the measured SNR.

6. The broadcast receiving apparatus of claim 5, further comprising:
a storage unit which stores a first threshold value and a second threshold value, wherein, if the measured SNR is greater than the first threshold value, the control unit generates a control signal to cause the broadcast signal not to be amplified, or if the measured SNR is smaller than the second threshold value, the control unit generates a control signal to cause the broadcast signal to be amplified.

7. A signal processing method comprising:
extracting a transfer stream from a received radio frequency (RF) signal;
measuring a signal to noise ratio (SNR) of the transfer stream;
comparing the measured SNR with a threshold; and
operating an amplifier, which is provided to amplify the RF signal, based on a result of the comparing.

8. The signal processing method of claim 7, wherein the extracting, the measuring, the comparing and the operating are performed repeatedly at predetermined time intervals.

9. The signal processing method of claim 7, wherein the measuring comprises:
measuring the SNR of the transfer stream at predetermined time intervals.

10. The signal processing method of claim 7, wherein the operating comprises:
turning the amplifying unit into an amplification on state or an amplification off state.

11. The signal processing method of claim 7, wherein the comparing comprises:
comparing the SNR with a first threshold and a second threshold, which is smaller than the first threshold; and
one of turning the amplifying unit into an amplification off state, if the SNR is greater than the first threshold, and turning the amplifying unit into an amplification on state, if the SNR is smaller than the second threshold.

12. The signal processing method of claim 7, wherein the amplifying unit comprises a low noise amplifier (LNA).

13. An apparatus comprising:
extracting means for extracting a transfer stream from a received radio frequency (RF) signal;
control means for measuring a signal to noise ratio (SNR) of the extracted transfer stream and comparing the measured SNR with a first predetermined threshold value and a second predetermined threshold value; and
amplifying means for one of turning on a signal amplifier, turning off a signal amplifier, and maintaining a current state of a signal amplifier based on comparing.

14. The apparatus of claim 13, wherein the control means compares the measured SNR to the first threshold value prior to comparing the measured SNR to the second threshold value, which is smaller than the first threshold value.

15. The apparatus of claim 14, wherein the amplifying means turns off the signal amplifier if the measured SNR is greater than the first threshold value and the control means compares the measured SNR to the second threshold value if the measured SNR is smaller than or equal to the first threshold value.

16. The apparatus of in claim 15, wherein the amplifying means maintains the current state of the signal amplifier if the measured SNR is greater than or equal to the second threshold value and turns the signal amplifier on if the measured SNR is smaller than the second threshold value.

17. The apparatus of claim 13, further comprising: a storage device which stores the first and second threshold values.
